(19) United States
(12) Patent Application Publication
(10) Pub. No.: US 2009/0084488 A1
(43) Pub. Date: Apr. 2, 2009

(54) Method of preparing colorless and transparent f-doped tin oxide conductive film using polymer post-treatment process

(75) Inventors: Sang Hak Kim, Gyeonggi-do (KR); Sun Mi Oh, Gyeonggi-do (KR); Doh Hyung Riu, Seoul (KR); Seung Hun Huh, Seoul (KR); Chan Yeol Kim, Gyeonggi-do (KR); Kwang Youn Cho, Seoul (KR); Chul Kyu Song, Gyeonggi-do (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 12/006,208

(22) Filed: Dec. 31, 2007

(30) Foreign Application Priority Data
Oct. 1, 2007 (KR) 10-2007-0098568

(51) Int. Cl. B29C 65/02; B05D 5/12

(52) U.S. Cl. 156/103; 427/108

(57) ABSTRACT

The present invention provides a method of preparing a colorless and transparent FTO conductive film using a polymer post-treatment process, in which a polymer is coated or bonded to an FTO film having a low transmittance due to optical coloring, thereby increasing the transmittance.

### CROSS-REFERENCE TO RELATED APPLICATION

This application claims under 35 U.S.C. §119(a) on Korean Patent Application No. 10-2007-0098568, filed on Oct. 1, 2007, the entire contents of which are incorporated herein by reference.

### BACKGROUND

(a) Technical Field

The present invention relates to a method of preparing a colorless and transparent fluorine-doped tin oxide (FTO) conductive film using a polymer post-treatment process which improves optical properties of FTO.

(b) Background Art

A transparent conductive oxide (TCO) film is a material that is highly transparent and electrically conductive as it means. The TCO film is necessarily applied to various industrial fields such as displays, transparent heating elements, and the like.

Generally, if the TCO film has a transmittance of 75% or higher and a surface resistance of 5 Ω or lower, the TCO film can be used as a display element or a transparent heating element having no visual obstacle, such as an electrically heating windshield glass for a vehicle.

The electrically heating windshield glass for a vehicle should electrically generate heat for defrosting or defogging within a short period of time (low resistance), while not disturbing the visual field of a driver (transmittance at least 75%).

At this time, to meet the requirements of minimum transmittance of 75% and maximum surface resistance of 5 Ω, the TCO film should have a thickness of at least 500 nm to 800 nm. However, the thicker the film, the lower the transmittance becomes. Moreover, if the thickness is reduced to increase the transmittance, the resistance is reduced.

In general, when the thickness of the TCO film is in the range of the wavelengths of the visible light, “optical coloring” occurs, and the non-uniformity of the film due to upsizing shows various colors like a rainbow by diffusion, interference and diffraction of various incident lights. If the surface of the film is rough, the incident light is blurred on the surface of the film by irregular reflection, which is called “haze.”

Such phenomena are directed to extrinsic optical properties, which are distinct from intrinsic optical properties and will be described in more detail with reference to FIG. 1 below.

In the case where the thickness of the TCO film is in the range of the visible light as shown in FIG. 1A, in the case where the thickness of the TCO film is not uniform as shown in FIG. 1B, and in the case where the surface of the TCO film is rough as shown in FIG. 1C, the optical properties of the FTO film are all degraded.

The haze is inevitably formed as seen from the relationship of low resistance, high quality FTO crystal growth, irregular reflection of incident light, and haze in sequential order, and thus the upsizing of the high quality TCO causes the optical coloring and haze more or less.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE DISCLOSURE

Accordingly, the present invention has been made in an effort to solve the above-described drawbacks in that the transmittance is reduced by optical coloring and haze formed on a fluorine-doped tin oxide (FTO) film among transparent conductive oxide (TCO) films.

In one aspect, the present invention provides a method of preparing a colorless and transparent FTO conductive film, the method comprising: providing a glass substrate; forming a SiO2 barrier layer on the glass substrate; forming an FTO film on the barrier layer; and applying a polymer onto the FTO film.

In a preferred embodiment, the FTO film is formed on the barrier layer by spray coating or ultrasonic atomization.

In another preferred embodiment, the polymer is applied onto the FTO film by coating or bonding. Preferably, the polymer may be applied onto the FTO film by spin coating or dip coating a polymer solution on the FTO film. Also preferably, the polymer may be applied onto the FTO film by bonding a polymer sheet to the FTO film by thermal or vacuum compression. The thermal compression is performed, for instance, by interposing the polymer sheet between the FTO film coated on the glass substrate and an ordinary glass substrate having the same size as the FTO film coated glass substrate and compressing them in the temperature range of 80 to 110° C. The vacuum compression is performed, for example, by interposing the polymer sheet between the FTO film coated on the glass substrate and an ordinary glass substrate, initially heat-treating them in a polymer case under vacuum and in the temperature range of 80 to 110° C. for 10 to 40 minutes, and subsequently heat-treating under a gas pressure atmosphere of about 2 to 20 atmospheric pressure and in the temperature range of 80 to 110° C. for 1 hour.

In another aspect, the present invention provides a method of preparing a colorless and transparent FTO conductive film, the method comprising: providing a glass substrate; forming an FTO film on the glass substrate; and applying a polymer onto the FTO film.

Suitable examples of the polymer include polyvinyl alcohol (PVA), polyvinyl butyral (PVB) and polymethylmethacrylate (PMMA).

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

Other aspects of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram illustrating examples of optical coloring and haze on FTO transparent conductive films;

FIG. 2 is a scanning electron microscope (SEM) photograph of an FTO transparent conductive film having a thickness of about 450 nm formed by a spray coating method;

FIG. 3 is a photograph taken before and after spin-coating a PVA film on the FTO transparent conductive film of FIG. 2 in accordance with Example 1 of the present invention;

FIG. 4 is a graph showing the results of UV-Visible (UV-Vis) spectral analysis on the samples of FIG. 3;

FIG. 5 shows a scan image of an FTO film formed in accordance with Example 2 and having a thickness of about 1 μm, and an image taken after performing a thermal compression process of a PVA film having a thickness of about 1 mm on the FTO film at about 90° C. for 30 seconds; and

FIG. 6 is a graph showing the results of UV-Vis spectral analysis on the samples of FIG. 5.

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

As illustrated above, the haze of an FTO film is caused by surface irregular reflection due to the rough surface, and the optical coloring phenomenon is caused by interference and diffusion of incident light due to the non-uniformity of the thickness of the FTO film. Accordingly, the present invention provides a method of preparing a colorless and transparent FTO conductive film using a polymer post-treatment process, in which extrinsic optical properties of the FTO film such as low transmittance and optical coloring are eliminated through a simple post-treatment process and intrinsic optical properties such as high transmittance and colorlessness of the FTO film are obtained.

Existing transparent conductive films have reached the limits in terms of quality improvement, i.e. intrinsic optical properties. Taking this into consideration, the present invention aims at improving the quality of the existing FTO film through a simple polymer post-treatment process, and improving the extrinsic properties of the FTO film, not the intrinsic properties, thus providing a material of high quality.

Here, the method of preparing a colorless and transparent FTO conductive film in accordance with the present invention will be described in sequential order.

The preparation method of the present invention is generally divided into a process of preparing an FTO film and a polymer post-treatment process.

The process of preparing an FTO film is a series of processes including heating a glass substrate to 400 to 600° C, forming a SiO₂ barrier layer, and forming an FTO film on the barrier layer using a spray coating or ultrasonic atomization method.

The polymer post-treatment process includes a polymer coating process and a polymer bolding process.

First, the polymer coating process is a process of dropping a polymer solution on the FTO film formed as described above to be coated by spin coating or dipping the FTO film in the polymer solution to be coated by dip coating.

Second, the polymer bonding process is performed by a simple thermal compression process in case of a small-sized substrate or by a vacuum compression process in case of a large-sized substrate.

The simple thermal compression process is used for a small-sized glass substrate. More particularly, a polymer sheet is interposed between a small-sized glass substrate, on which an FTO film is coated, and an ordinary glass substrate having the same size and then thermally compressed in the temperature range of 80 to 110° C.

However, in case of a large-sized or curved substrate, since the glass may be broken or it is difficult to remove all air on the polymer sheet, the vacuum compression process is employed. More particularly, the vacuum compression process is performed by placing a sample, which is prepared by interposing a polymer sheet between an FTO film formed on a large-sized or curved substrate and an ordinary glass substrate, into a polymer case; subjecting the sample to a primary vacuum heat-treatment in the temperature range of 80 to 110° C. for 10 to 40 minutes and then a secondary heat-treatment under a gas pressure atmosphere of about 2 to 20 atmospheric pressure and in the temperature range of 80 to 110° C. for 1 hour.

Through the above processes, the air on the polymer sheet is completely removed and the compression between the FTO film and the ordinary glass substrate with the polymer interposed therebetween is achieved.

The FTO film is prepared by atomizing a precursor solution into micro droplets by a spray coating or ultrasonic atomization method to be coated on a heated glass substrate, which is directed to a pyrosol process well known in the art as a kind of a room temperature chemical vapor deposition (CVD).

The precursor solution for preparing the FTO film is formed in such a manner that SnCl₄.5H₂O is dissolved in an ethanol solution to be 0.68 M, NH4F as a fluorine dopant is dissolved in triple distilled water to be 2.3 M, and the two solutions are mixed, stirred and then filtered.

Moreover, in addition to the above precursor solution, 1 to 10 wt % of ethylene glycol as an additive may be added, the composition ratio of water and ethanol may vary, the amount of NH₄F may vary from 0.1 to 3 M, and 0 to 2 M of hydrofluoric acid (HF) may be added to adjust the amount of the fluorine dopant, thus preparing various types of FTO films.

It should be noted, however, the precursor solution for preparing the FTO film is not limited to the above composition.

However, description will be given of an example of a precursor solution SnCl₄.5H₂O(0.68 M)/EtOH+NH₄F(2.3M)/H2O for better understanding of the present invention.

When the ordinary glass used as a substrate is heated to 400 to 600° C., impurities such as Na, K and the like contaminate the surface of the glass substrate, which degrades the adhesive force between the glass substrate and the FTO film and deteriorates the film quality. Accordingly, it is necessary to form a barrier layer for preventing impurities from being introduced between the glass substrate and the FTO film.

As the barrier layer, a ceramic layer such as SiO₂ and TiO₂ is generally used; however, in the present invention, the SiO₂ barrier layer is formed with a thickness of about 5 to 50 nm by a dip coating or spray coating method.

That is, the dip coating method is employed in case of a small-sized substrate and the spray coating method is employed in case of a large-sized or curved substrate to form the SiO₂ barrier layer.

In the dip coating method, a silica sol formed by mixing 95% ethanol, tetraethyl silicate and nitric acid in a volume ratio of 90:11:0.5 is dip coated at a rate of 150 mm/min and heat-treated in the temperature range of 200 to 300° C. for 5 minutes, thus forming a SiO₂ barrier layer.

In the spray coating method used in case of a large-sized or curved substrate, a silane agent such as SiH₄, SiH₂Cl₂, or Si(OC₂H₅)₂ is coated on a glass substrate heated to 400 to 600° C. in an air or under an oxygen atmosphere using a CVD method, thus simply forming a barrier layer.

On the other hand, in the case where a high quality glass is used, that is, in the case where a glass substrate, e.g., a borosilicate glass, having little impurities such as Na, K and the like is used, it is not necessary to form the barrier layer.

Here, the process of preparing an FTO film will be described in detail.

The FTO film is formed on the glass substrate, on which the SiO₂ barrier layer is coated as described above, by a spray coating, ultrasonic atomization, or ultrasonic spray coating method in the temperature range of 400 to 600° C.

In the spray coating method, a liquid precursor is atomized into micro droplets by a liquid attracting force generated when an external gas is expanded and discharged through a fine nozzle.

In the ultrasonic atomization method, a liquid precursor is atomized by an ultrasonic vibrator and carried via a carrier gas like an ultrasonic humidifier.

In the ultrasonic spray coating method, the ultrasonic vibrator is modified like a spray nozzle and the atomized precursor is sprayed.

Subsequently, the polymer coating or polymer bonding process as the post-treatment is performed on the thus formed FTO film to obtain more transparent FTO film.

That is, as described above, the polymer coating process is performed by dropping the polymer solution on the thus formed FTO film to be coated by spin coating or dipping the FTO film in the polymer solution to be coated by dip coating.

The polymer bonding process is performed by a simple thermal compression process or a vacuum compression process.

Meanwhile, the thickness of the polymer film obtained by spin coating is set in the range of 80 to 130 nm by Formula 1 and the thickness can be obtained by adjusting the RPM of the spin coater.

Dpva=(λ/4)×(1/n ) [Formula 1]

wherein Dpva represents the thickness of a polyvinyl alcohol (PVA) film, λ represents a wavelength of incident light, and n represents a reflective index of the material used.

In more detail, if a reflective index of about 1.5 is applied to an incident light wavelength of 500 to 800 nm, a PVA film having a thickness of about 80 to 130 nm may be obtained.

The above formula 1 is well known in the art as a top antireflection coating (TARC) and widely used in semiconductor processes.

Next, the present invention will be described in more detail with reference to Examples, but the scope of the present invention should not be limited to these Examples.

### EXAMPLE 1

As a glass substrate, a vehicle window glass was used. The glass substrate was heated to about 500° C. and a SiO₂ barrier layer was formed with a thickness of about 20 nm on the glass substrate.

Subsequently, a precursor solution for preparing an FTO film, formed in such a manner that SnCl₄.5H₂O was dissolved in an ethanol solution to be 0.68 M, NH4F as a fluorine dopant was dissolved in triple distilled water to be 2.3 M, and the two solutions were mixed, stirred and then filtered, was coated on the glass substrate, on which the SiO₂ barrier layer was formed, at a temperature of about 500° C. by a spray coating method.

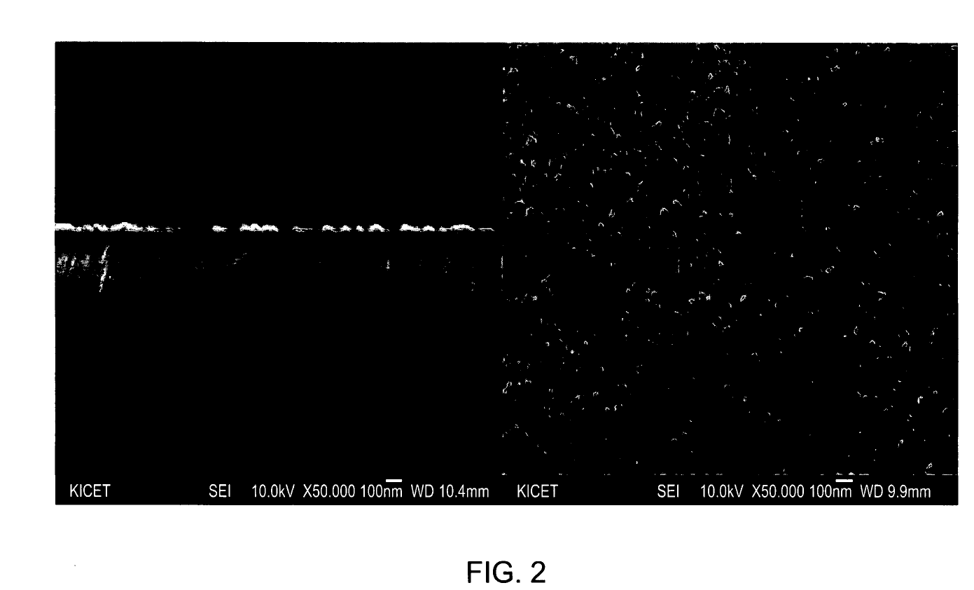

As a result, FIG. 2 shows a scanning electron microscope (SEM) photograph of the FTO film formed of the above precursor solution by the spray coating method, in which the FTO film had a thickness of about 400 nm and a surface resistance of about 5 Ω with a rough surface.

Moreover, as a result of an X-ray photoelectron spectroscopy (XPS) analysis, the O/Sn ratio was 1.9 (molar ratio) and, as a result of an energy dispersive spectrometry (EDS) analysis, the F/Sn ratio was 0.59 (molar ratio).

However, since it is known that the quantitation of light elements such as F and O is very difficult in the FTO film differently from metal elements, there is a difference of almost three times, although it may be varied according to the analysis methods.

Next, a polymer solution was dropped on the FTO film to be coated by spin coating and the polymer used was polyvinyl alcohol (PVA).

### TEST EXAMPLE 1-1

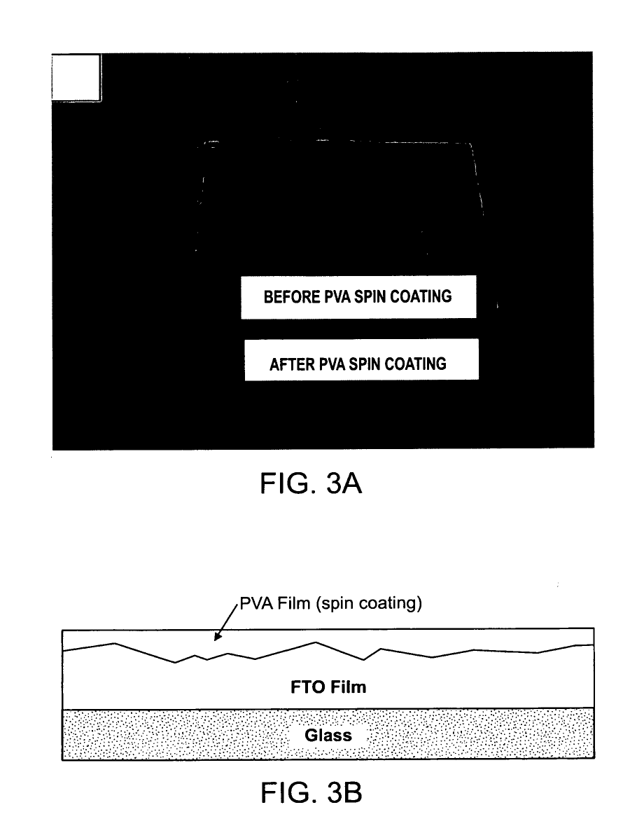

The FTO film prepared in accordance with Example 1 was visually observed. As a result, FIG. 3 shows a photograph of the FTO film before and after spin-coating a polymer having a high transmittance, i.e., polyvinyl alcohol (PVA), on the FTO film.

As shown in the photography of FIG. 3, it can be understood that the FTO film on which the polymer has been coated by spin coating becomes more transparent compared with the FTO film before the polymer coating.

Meanwhile, although the polymer used was polyvinyl alcohol (PVA), favorable results were obtained even when polyvinyl butyral (PVB) was used. Accordingly, it can be understood that the kind of polymer has little affect on the process of increasing the transparency through the post-treatment and thus it is possible to use polymethylmethacrylate (PMMA) having excellent transmittance besides the above two polymers.

### TEST EXAMPLE 1-2

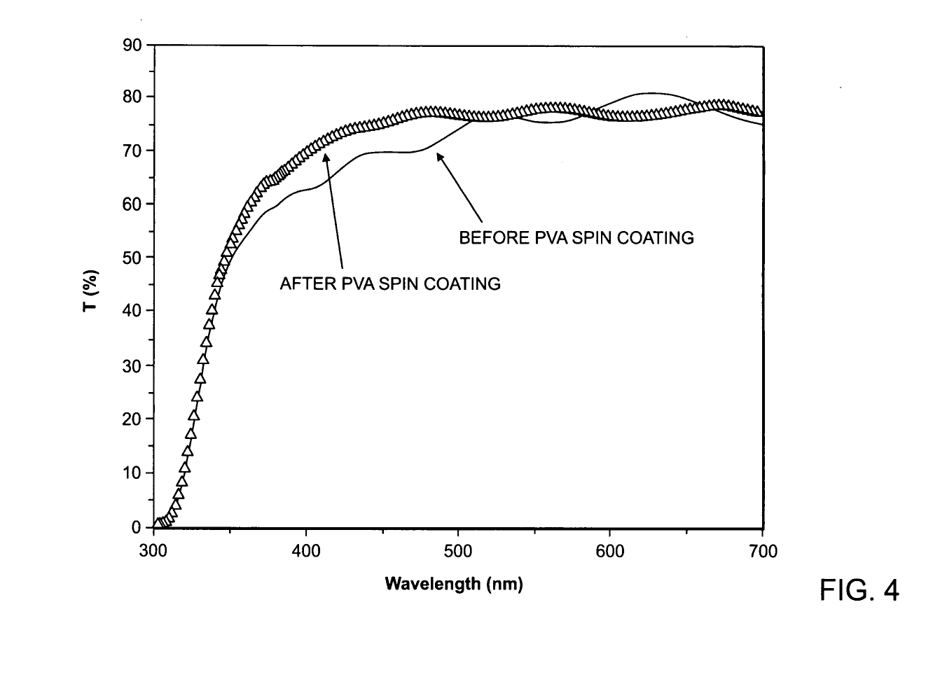

The effect of the polymer coating in the post-treatment process was measured by UV-Visible (UV-Vis) spectral analysis, and the results are shown in the graph of FIG. 4.

In the FTO film before the polymer coating as a comparative example, a lot of oscillations can bee seen in the range of the visible light, which means that the optical coloring is caused by the diffusion, interference and diffraction of various visible light wavelengths, in other words, the FTO film is seen as a rainbow.

However, as shown in the graph of FIG. 4, it can be seen from the FTO film spin-coated with the polymer that such oscillations become weaker, which means that the FTO film becomes colorless and transparent, and thus the transmittance is increased.

### EXAMPLE 2

An FTO film having a thickness of about 1 μm was formed on a glass substrate using the ultrasonic atomization method.

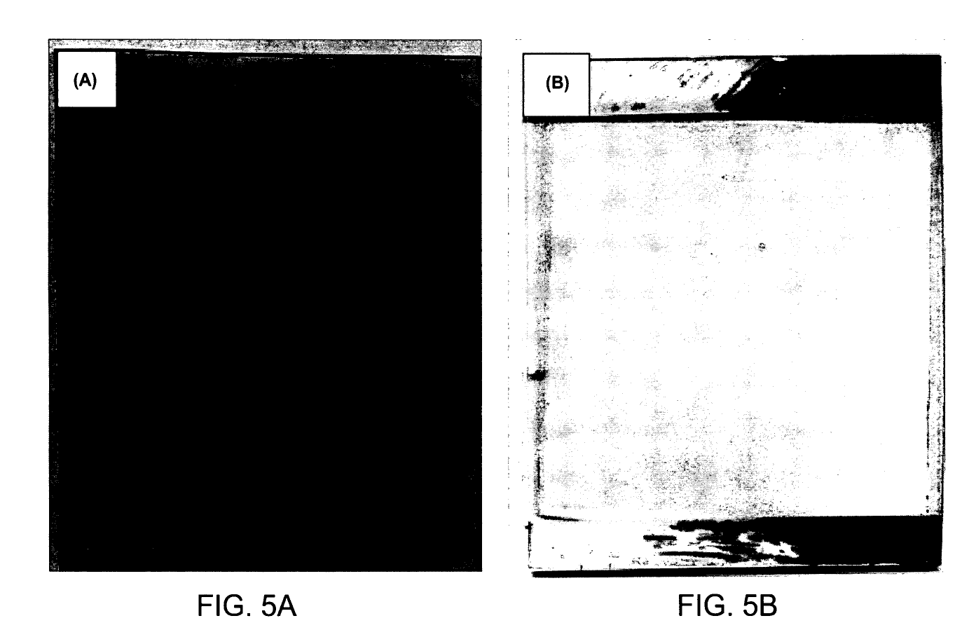

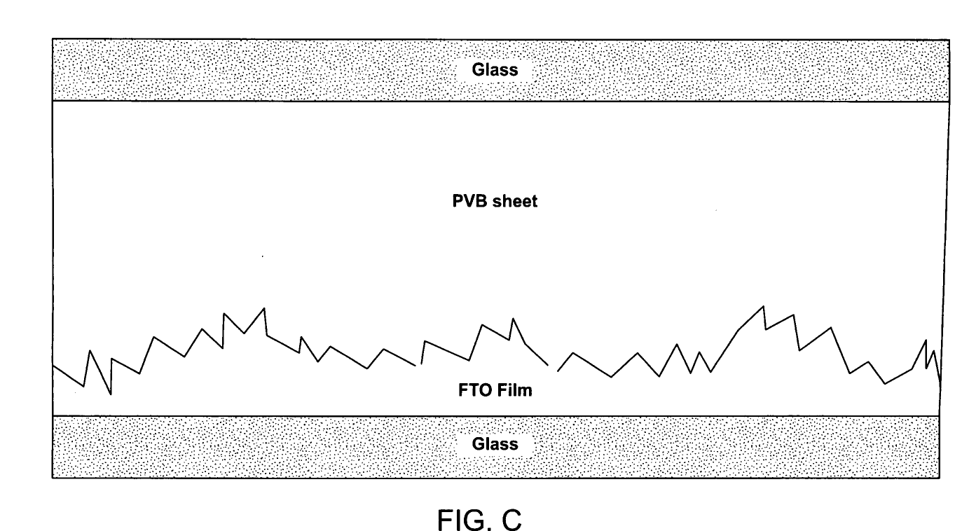

The glass substrate used was heated to about 500° C, the surface resistance was about 5 Ω, and the thus formed FTO film was seen as a rainbow and blurred as shown in FIG. 5A.

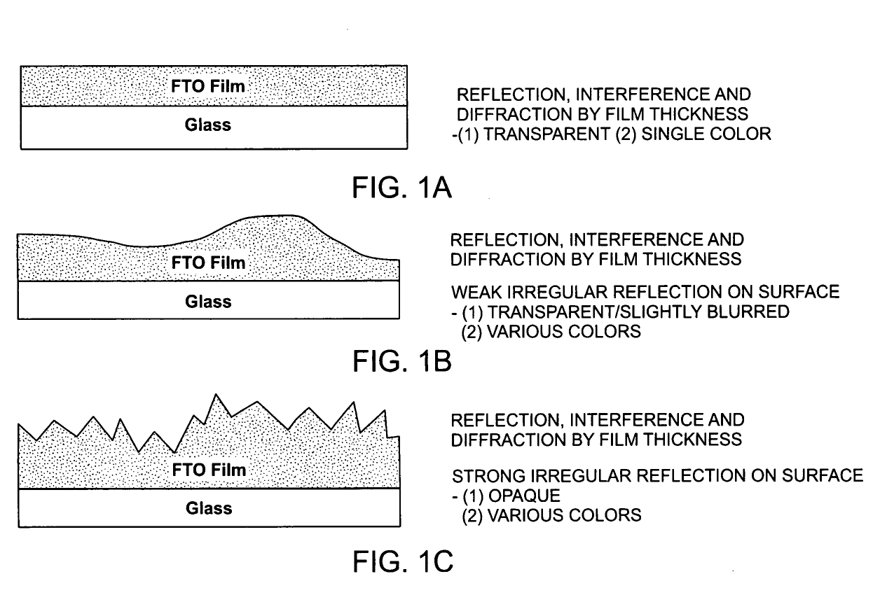

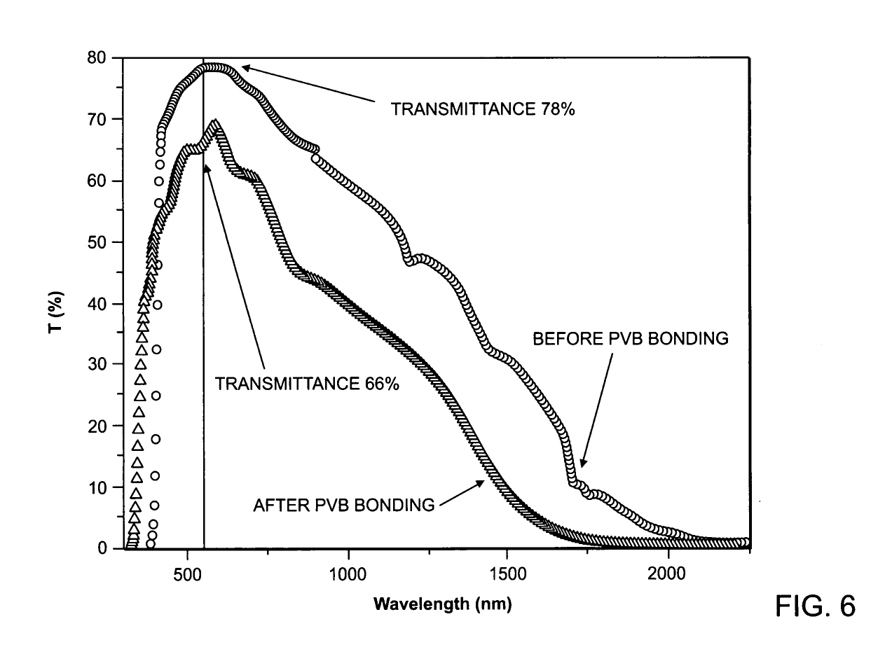

As a result of the SEM analysis, the thickness of the FTO film was not uniform and the surface of the FTO film was very rough by grains like the sample shown in FIG. 1C. As shown in the graph of FIG. 6 showing the results of UV-Vis spectral analysis, the transmittance was reduced to about 60% and considerable oscillations (various colors) were observed in the range of the visible light.

Then, a polymer sheet was interposed between the glass substrate, on which the FTO film was coated, and an ordinary glass substrate, and a thermal compression process was performed.

In more detail, a PVB sheet having a thickness of 1 mm as the polymer sheet was interposed between the glass substrate, on which the FTO film was coated, and an empty glass substrate, and a thermal compression process was performed at about 90° C., of which the schematic diagram is shown in FIG. 5C.

### TEST EXAMPLE 2

The FTO film prepared in accordance with Example 2 was visually observed. As a result, it can be seen from the scan image of FIG. 5B that the color is removed and the thus FTO film is seen as transparent even with naked eyes.

UV-Vis spectral analysis was also made. It can be understood from the graph of FIG. 6 that, even though the glass substrate and the PVB sheet were bonded thereto, the transmittance was 78%, increased 11% compared with 67% before the PVB thermal compression (on the basis of 550 nm).

Furthermore, it can be seen that the overall transmittance was increased in the other wavelengths and there were no oscillations formed by the rainbow colors on the FTO substrate having no polymer sheet (refer to FIG. 5A).

Like this, it can be understood that the low quality FTO product having a surface resistance of 5 Ω and a transmittance of 67% can be turned into a high quality FTO product having a surface resistance of 5 Ω and a transmittance of 78% through the post-treatment process of the PVB thermal compression.

### EXAMPLE 3

An FTO substrate having a curved surface of about 10% was subjected to a polymer bonding process.

That is, a PVB sheet as a polymer sheet was placed on an FTO film, an ordinary glass substrate having the same shape was covered thereon, and the resulting substrate was placed into a polymer bag to be subjected to a primary vacuum heat-treatment at about 100° C. for about 30 minutes and then subjected to a secondary heat-treatment under a gas pressure atmosphere of about 10 atmospheric pressure and at about 100° C. for 1 hour.

As a result, the coloring and haze of the FTO film were considerably reduced the same as Example 2.

Meanwhile, in the event that a UV-curing method was employed to form a polymer film instead of the spin coating and dip coating methods, the same results were obtained.

As described above, according to the method of the present invention, it is possible to obtain a colorless and transparent FTO conductive film, in which the optical coloring effect is reduced and the light transmittance is increased, through a process of forming an FTO film on a heated substrate by a spray coating or ultrasonic atomization method and a series of post-treatment processes of spin-coating or dip-coating a polymer having excellent transmittance in the rage of the visible light and thermally compressing a polymer sheet.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of preparing a colorless and transparent fluorine-doped tin oxide (FTO) conductive film, the method comprising:
providing a glass substrate forming a SiO₂ barrier layer on the glass substrate;
forming an FTO film on the barrier layer; and applying a polymer onto the FTO film.

2. The method of claim 1, wherein the FTO film is formed on the barrier layer by spray coating, ultrasonic atomization or ultrasonic spray coating.

3. The method of claim 1, wherein the polymer is applied onto the FTO film by coating or bonding.

4. The method of claim 3, wherein the polymer is applied onto the FTO film by spin coating or dip coating a polymer solution on the FTO film.

5. The method of claim 3, wherein the polymer is applied onto the FTO film by bonding a polymer sheet to the FTO film by thermal or vacuum compression.

6. The method of claim 5, wherein the thermal compression is performed by interposing the polymer sheet between the FTO film coated on the glass substrate and an ordinary glass substrate having the same size as the FTO film coated glass substrate and compressing them in the temperature range of 80 to 110° C.

7. The method of claim 5, wherein the vacuum compression is performed by interposing the polymer sheet between the FTO film coated on the glass substrate and an ordinary glass substrate, initially heat-treating them in a polymer case under vacuum and in the temperature range of 80 to 110° C. for 10 to 40 minutes, and subsequently heat-treating under a gas pressure atmosphere of about 2 to 20 atmospheric pressure and in the temperature range of 80 to 110° C. for 1 hour.

8. The method of claim 1, wherein the polymer is any one selected from the group consisting of polyvinyl alcohol (PVA), polyvinyl butyral (PVB) and polymethylmethacrylate (PMMA).

9. A method of preparing a colorless and transparent fluorine-doped tin oxide (FTO) conductive film, the method comprising:
providing a glass substrate;
forming an FTO film on the glass substrate; and
applying a polymer onto the FTO film.

10. The method of claim 9, wherein the FTO film is formed on the glass substrate by spray coating, ultrasonic atomization or ultrasonic spray coating.

11. The method of claim 9, wherein the polymer is applied onto the FTO film by coating or bonding.

12. The method of claim 11, wherein the polymer is applied onto the FTO film by spin coating or dip coating a polymer solution on the FTO film.

13. The method of claim 11, wherein the polymer is applied onto the FTO film by bonding a polymer sheet to the FTO film by thermal or vacuum compression.

14. The method of claim 13, wherein the thermal compression is performed by interposing the polymer sheet between the FTO film coated on the glass substrate and an ordinary glass substrate having the same size as the FTO film coated glass substrate and compressing them in the temperature range of 80 to 110° C.

15. The method of claim 13, wherein the vacuum compression is performed by interposing the polymer sheet between the FTO film coated on the glass substrate and an ordinary glass substrate, initially heat-treating them in a polymer case under vacuum and in the temperature range of 80 to 110° C. for 10 to 40 minutes, and subsequently heat-treating under a gas pressure atmosphere of about 2 to 20 atmospheric pressure and in the temperature range of 80 to 110° C. for 1 hour.

16. The method of claim 9, wherein the polymer is any one selected from the group consisting of polyvinyl alcohol (PVA), polyvinyl butyral (PVB) and polymethylmethacrylate (PMMA).
